(19) United States
(12) Patent Application Publication
(10) Pub. No.: US 2004/0163733 A1
(43) Pub. Date: Aug. 26, 2004

(54) Integrated tool holder and work surface

(75) Inventor: Bryan M. Herrera, Boise, ID (US)

Correspondence Address: DEREK H. MAUGHAN, DYKAS, SHAVER & NIPPER, LLP, P.O. BOX 877, BOISE, ID, 83701-0877, US

(73) Assignee: Material Concepts, LLC, Boise, ID (US)

(21) Appl. No.: 10/786,909

(22) Filed: Feb. 24, 2004

Related U.S. Application Data
(60) Provisional application No. 60/450,101, filed on Feb. 24, 2003.

(51) Int. Cl. B25H 1/00

(52) U.S. Cl. 144/286.1

(57) ABSTRACT

A tool holder for up to six tools at a time, which can also be used as an eyelet setting surface, such as punching holes in paper with the hole punch and setting eyelets with the eyelet setter. This tool holder also protects the tabletop or any work surface from being damaged by the tools.

### PRIORITY

This application claims priority from a provisional patent application, U.S. Pat. App. No. 60/450,101 filed by the same inventor on Feb. 24, 2004. The contents of that application are herein incorporated by reference.

### BACKGROUND OF THE INVENTION

1. Field of the Invention

This invention generally relates to tools used in arts and crafts, and more particularly to an integrated tool and system for storing, retrieving, and using those hand tools.

2. Background of the Invention

In many types of projects, a variety of types of tools are utilized to mark, cut or punch a work piece. In many of these applications, a plurality of these types of devices each having different various configurations have been utilized to obtain a desired result in the work piece itself. In recent times, arts and craft projects have become increasingly more popular and practiced by a variety of persons. Among these types of projects are those that are commonly referred to as scrapbooking projects. A variety of types of persons who engage in so-called scrapbooking arrange a variety of objects, photographs, and other information in artistic displays and place these so-called “scrapbook pages” within a book for later review. These types of projects are particularly enjoyed by women with families and children, and provide a creative and artistic form of documenting a family's history.

Among the features that are increasingly more desired for inclusion among scrapbooking persons are items referred to as eyelets, which are configured in a variety of decorative ways and are used to embellish a typical scrapbook page.

Typically, these eyelets are inserted within a hole that is punched through a piece of paper or other item. The eyelets are then deformed by a force producing device (called an eyelet setter), which bends a pair of flanges that extend from the eyelet around an item such as a piece of paper through which the eyelet has been placed. The resulting eyelet is then placed within the piece of paper or other item so as to produce a desired artistic effect.

One of the problems with placing such eyelets is that the tools that are used to place these eyelets are typically tools that are better configured for other types of activities. Often times these typical tools are large and unwieldy, particularly for use by females who make up a large part of the scrapbooking community. Another problem that occurs is that many times the locations in which scrapbooking is done is not conducive to having pounding and punching activities take place and many times damage to furniture and other items can occur. Another problem that can occur is that the tools, which are used in punching material and placing eyelets, can be lost or misplaced.

Therefore what is needed is a system of tools for placing eyelets that are configured for grasping by individuals having smaller hands. What is also needed is a system of tools that can be contained within a device, which can also be used as an anvil type surface for punching material and placing eyelets.

Therefore, it is an object of this invention to provide a system of tools for placing eyelets that are configured for grasping by individuals with smaller hands. An additional object of the invention is to provide a station that can be utilized to hold a plurality of tools and which also has the ability to be used as an anvil and/or work surface for punching material and placing grommets and eyelets therein.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a system configured for storing, retrieving, and utilizing hand tools for placing eyelets in a material. The system is made up of a container configured to withstand pounding from a conventional hammer. This container has a top configured for removable connection with a compatibly configured lid, a first side, a second side, and a body. The body may be made from any of a variety of materials, such as a metal, aluminum or a hard plastic. This body may be either clear or colored to accommodate the necessities of a user or potential consumer. The body defines a plurality of chambers, each chamber configured to hold one of a plurality of desired tools therein. Depending upon the tools to be used, the exact dimensions of the device and the chambers within the device may be variously modified.

A series of tools are configured for use within the device. The tools include a tool referred to as an anywhere punch, which is configured to perform a variety of punching functions, as well as at least one eyelet setter configured to deform a portion of an eyelet to place an eyelet within a desired location. These tools are dimensioned to fit within the chambers of the device.

A hammer is configured for use in conjunction with the device. The hammer has a head and a handle configured to be used in conjunction with any one of the desired punching tools to perform a function connected with placing a deforming a device such as a grommet.

The container of the device is configured to serve as a workstation or an anvil and to allow pounding of the punches and setters thereupon. This prevents damage to any underlying surface such as a table or other piece of furniture. This device also allows a workstation to be transported from one location to another, with the associated tools carried therein.

Further, the purpose of the foregoing abstract is to enable the United States Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measure by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is perspective assembly view of a first embodiment of the present invention.

FIG. 2 is a perspective view of the end cap of the present invention.

FIG. 3 is a plan cross-sectional view of the preferred embodiment of the invention.

FIG. 4 is an assembly view of the preferred embodiment of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

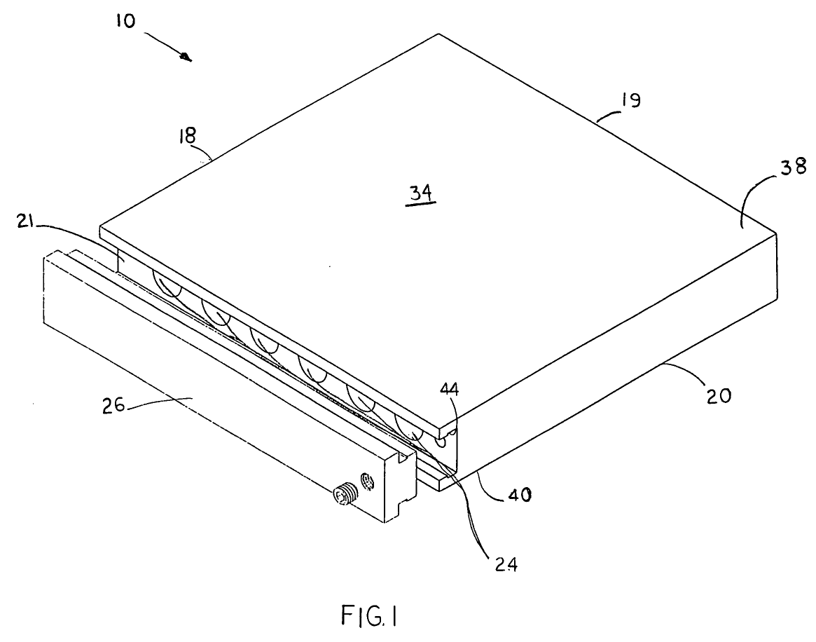

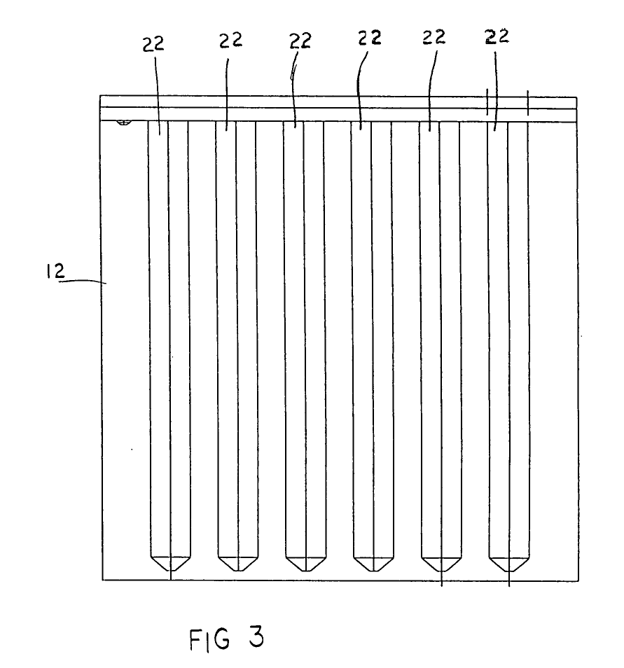

Referring now to FIGS. 1-4, various views of the preferred embodiment of the invention are shown. FIG. 1 shows a perspective view of the present invention. The present invention is a combination tool holder and work surface. The present invention is comprised of a container 10 having a body, with said body having a generally flattened box type shape. Container 10 having a pair of first surfaces 18, 19 positioned generally opposite two second surfaces 20, 21 and a top 38 and bottom 40 positioned generally opposite one another. While the preferred embodiment is shown as being a generally flattened box type shape, it is to be distinctly understood that the invention is not limited thereto but may be variously embodied to include a variety of alternative shapes and configurations. The body is also configured to contain a plurality of chambers 22 (shown in FIG. 3). These chambers 22 each have openings 24 that allow an individual to have access to the chambers 22 that are positioned within the body 12.

The size and dimensions of the chambers 22 are dependent upon a variety of factors including the size of the tools that are to be utilized with these devices. In the preferred embodiment, the chambers 22 are configured to hold and maintain eyelet-setting tools such as punches, setters, and other devices. However, it is to be distinctly understood that the dimensions of the chambers may be alternatively varied to include a variety of other types of devices. Examples of such tools include, but are not limited to devices such as leatherworking tools such as punches, awls and decorative designing devices, pens, pencils, markers, and other artistic devices, as well as cobblers' tolls such as those that are utilized in sewing and repairing shoes. In some instances, stamps, dies, die cutting devices, and other scrapbooking materials may also be incorporated and configured to use with the present invention.

A pounding work surface 34, 36 is positioned upon both the top 38 and bottom 40 of the body 12. In other embodiments, the work surfaces may be positioned only upon one of the surfaces. These pounding surfaces may be simply a portion of the material that the body 12 is made from or may another material that is attached to the body 12 through an attachment device such as a rivet, screw, or other attachment device. In some embodiments, the pounding surface 34, 36 is made of a material such as rubber, which allows the pounding to take place, but also limits the noise that is produced.

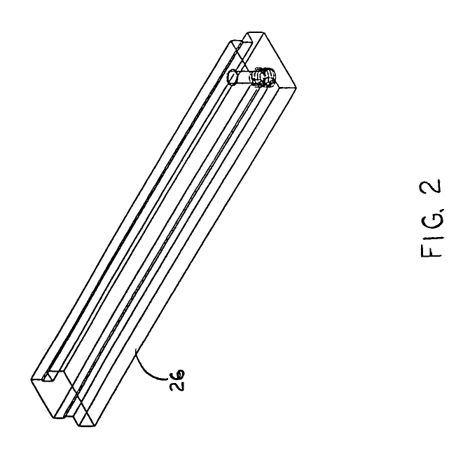

A lid 26 is connected to the body 12. In one preferred embodiment, the lid is configured to slide within a groove 44 defined with in the body 12 and to be held in place by an attachment device such as a screw. An example of such a lid is shown in FIG. 2. In another embodiment, the lid is shown as being connected to the body 12 through a hinge 28. This hinged connection allows the lid 26 to remain in contact with the body 12. This arrangement also comprises a locking means such as a snap fit locking device that allows the lid 26 to be snapped and held in a desired position.

In one embodiment, such as the invention shown in FIG. 1, the device is made from a ¾″ sheet of acrylic that is cut to a 4½ square. Standing on end, six individual holes, approximately 4¼″ long and ⅜″ in diameter, are drilled vertically into the acrylic. Each of the holes are spaced evenly apart and distributed evenly from side to side. The 4 1/4″ holes hold scrapbook eyelet setters and hole punches, which are 4″ long and made of 5/16″ hex stainless steel. The top of the 4½″×4½″ acrylic block has a slot cut on the inside for a lid to slide into. The lid is made of aluminum. It is approximately ¾″×½″×4½″. It has a ball bearing lock mechanism approximately ¼′ from one end of the lid. A cross-sectional view of this embodiment is shown in FIG. 3.

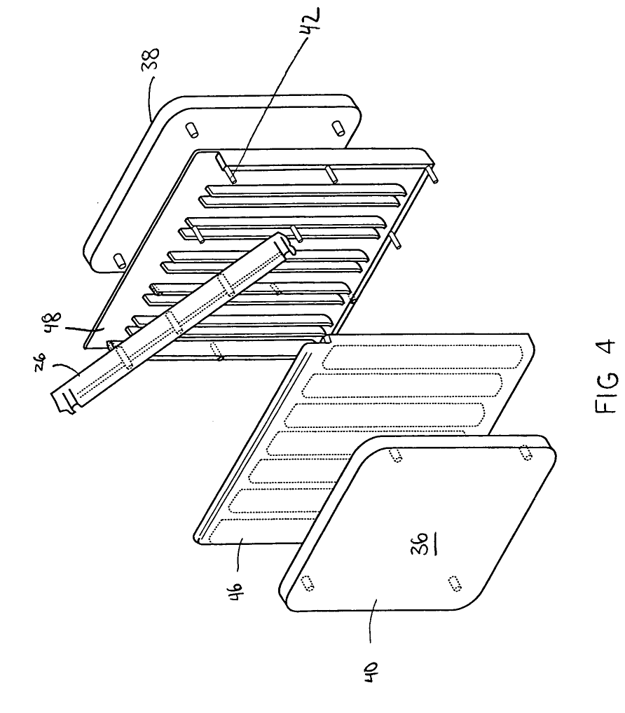

In the preferred embodiment of the invention that is found in FIG. 4, the body 12 is made of at least two portions 46, 48 of polycarbonate resins which are molded into the desired shape. Each piece 46, 48 is dimensioned and configured to make up one half of the chambered device. These halves 46, 48 are then assembled and placed together utilizing a connection means such as a screw, rivet or other connection device 42. The pounding or work surfaces 34, 36 are each then configured for connection upon the body 12. In this embodiment the work surfaces 34, 36 may be made of a more durable material than the body 12. The lid is hingedly connected to the body through a connector and is configured to be snapped and held in place by the connection between the lid and a spacer bar. At pair of work surface pads 30, 40 are attached to the body. These work surface pads 38, 40 and the lid 26 in this embodiment are made from an elastomer such as the material sold as SANTOPRENE® by Advanced Elastomer Systems. While this type of material is utilized in the present invention, it is to be distinctly understood that the invention is not limited thereto but may be variously embodied to meet the requirements and necessities of the user, and that in addition to these devices a variety of other devices may also be utilized.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A combination tool holder and work station comprising:
a body, said body defining a plurality of chambers therein, said chambers configured to receive and hold a selected number of tools therein;
a lid configured to connect with said body so as to hold said tools within said chambers; and
at least one pounding surface connected to said body.

2. The combination tool holder of claim 1 further comprising a second pounding surface.

3. The combination tool holder of claim 1 wherein said body is comprised of a durable plastic material.

4. The combination tool holder of claim 1 wherein said lid is connected to said body through a hinge.

5. The combination tool holder of claim 1 wherein said body is comprised of a durable transparent material.

6. The combination tool holder of claim 1 wherein said chambers are configured to eyelet setting tools therein.

7. The combination tool holder of claim 1 wherein said lid is configured to fit within a portion of said body.

8. The combination tool holder of claim 1 wherein said pounding surface is made of a durable rubber material.

9. The combination tool holder of claim 1 further comprising a second pounding surface.

10. The combination tool holder of claim 9 wherein said second pounding surface is made of a material different than said first pounding surface.

11. A combination tool holder and work station comprising:
a body, said have at least two pairs of opposing sides a top and a bottom, body defining a plurality of chambers therein, said chambers configured to receive and hold a selected tool of a designated size therein;
a lid connected to said body through a hinge, said lid configured to hold said tools within said chambers; and
at least one pounding surface connected to said body.

12. The combination tool holder of claim 11 further comprising a second pounding surface.

13. The combination tool holder of claim 11 wherein said body is comprised of a durable plastic material.

14. The combination tool holder of claim 11 wherein said lid is connected to said body through a hinge.

15. The combination tool holder of claim 11 wherein said body is comprised of a durable transparent material.

16. The combination tool holder of claim 11 wherein said chambers are configured to eyelet setting tools therein.

17. The combination tool holder of claim 11 wherein said lid is configured to fit within a portion of said body.

18. The combination tool holder of claim 11 wherein said pounding surface is made of a durable rubber material.

19. The combination tool holder of claim 11 further comprising a second pounding surface.

20. The combination tool holder of claim 19 wherein said second pounding surface is made of a material different than said first pounding surface.
